(19) United States
(12) Patent Application Publication
(10) Pub. No.: US 2014/0057805 A1
(43) Pub. Date: Feb. 27, 2014

(54) DNA-ORIGAMI-BASED STANDARD

(71) Applicants: Philip Tinnefeld, Braunschweig (DE); Juergen Schmied, Braunschweig (DE); Phil Holzmeister, Braunschweig (DE)

(72) Inventors: Philip Tinnefeld, Braunschweig (DE); Juergen Schmied, Braunschweig (DE); Phil Holzmeister, Braunschweig (DE)

(21) Appl. No.: 13/972,522

(22) Filed: Aug. 21, 2013

(30) Foreign Application Priority Data
Aug. 22, 2012 (DE) 10 2012 107 719.3

(51) Int. Cl. G01N 21/17

(52) U.S. Cl. CPC G01N 21/17
USPC 506/12; 506/16

(57) ABSTRACT

Arrays which utilize labeling molecules for calibrating a measuring device, such as microscopes, have a first structure based on a DNA origami as a calibration sample, wherein the DNA origami is formed into a predetermined structure by short DNA segments. The DNA origami is optionally present in an arranged manner on a support, wherein a number of short DNA segments which form the predetermined structure include a labeling molecule. Optionally, the array can have at least a second structure based on a DNA origami, different from the first structure, as a calibration sample. The array allows quantification of the labeling molecules on the basis of the number of photons per unit time.

The present invention is directed to standards suitable for calibrating measuring devices, more particularly microscopes. More precisely, the present invention relates to arrays for calibrating a measuring device using labeling molecules, wherein said array has a first structure based on a DNA origami as a calibration sample and wherein the DNA origami is formed into a predetermined structure by means of short DNA segments and is optionally present in an arranged manner on a support, wherein a predetermined number of the short DNA segments which can form the predetermined structure of the DNA origami has a predetermined number of a labeling molecule. Optionally, the array can have at least a second structure based on a DNA origami, different from the first structure, as a calibration sample. The array for measuring-device calibration is particularly suited for quantifying measurement signals, more particularly it allows quantification of the labeling molecules on the basis of the number of photons per unit time. In a further aspect, the application is directed to a method for calibrating a measuring device, such as a microscope, using the calibration sample according to the invention and also a kit for calibrating a measuring device and corresponding computer programs with program coding means which are stored on a machine-readable medium, set up for carrying out the method according to the invention when the computer program is executed on a processing unit.

### PRIOR ART

Quantitative analysis of samples and particular constituents of said samples requires prior calibration of the measuring device. One means of identifying the constituents to be analyzed comprises labeling said constituents with suitable labeling molecules. Said labeling molecules comprise both those which can be identified optically and those which can be determined with other physical measurement methods, for example radioactively, etc. Fluorescence measurement is one of the techniques which are gaining increasing importance especially in the area of microscopy, both in medical sciences and in biological sciences. It is based, inter alia, on the further development of resolution by, for example, super-resolution fluorescence microscopy methods. With these super-resolution microscopy techniques, a resolution in the nanometer range is possible. Examples of such methods are STED, (d)STORM, (F)PALM, PAINT, GSDIM and blink microscopy. Besides the high resolution, such fluorescence microscopes also allow determination of other parameters in order to provide information about the corresponding sample. Such information includes fluorescence intensity, fluorescence lifetime, fluorescence polarization, color and also fluorescence resonance energy transfer (FRET).

However, quantitative analysis using such microscopy techniques is limited in that there are only a few methods which allow calibration of these measuring devices, such as microscopes. Particularly the provision of standardized samples is limited, especially in submicrometer ranges right up to the ranges of super-resolution imaging and FRET. Top-down lithographic approaches can attain the required size dimensions, but can be combined only with great difficulty with the requirements on the molecular scale. In addition, such approaches are usually not biocompatible or optically compatible and influence, in particular, also the properties of the labeling molecules, such as the fluorescent dyes used in the area of fluorescence microscopy.

Chemical and macromolecular approaches, as used in bottom-up approaches, can form regular structures in the required size, but there is then a problem in the structural and stoichiometric determination in the ranges relevant to microscopy, since individual nano-objects such as fluorescent dyes cannot be placed at the relevant intervals.

Recently, DNA origami technology has been used to provide a tool which can have an effect on these above-described problems of the top-down and bottom-up approaches. Folded DNA origami are a simple and efficient way of creating two- and three-dimensional predetermined structures. Usually, in this case, via hybridization of short single-stranded DNA segments, so-called staple strands, to a long single-stranded scaffold DNA strand, the desired structures are created by formation and stabilization of the scaffold. As a result, it is possible to obtain predetermined structures after simple hybridization of these short DNA segments to the scaffold DNA. An advantage of these structures is their great stability and precise and predetermined dimensioning.

Through this approach, it is possible to exploit various unique properties of DNA: DNA is a supramolecular polymer and allows orthogonal isoenergetic recognition for specific interactions based on Watson-Crick base pairing. Said Watson-Crick base pairing forms the basis for the formation of the DNA origami structure and allows simple integration of (bio)chemical functionalities with subnanometer precision. DNA origami technology has already been used in various approaches for light microscopy and, in particular, for fluorescence microscopy: for instance, it is used for single-molecule analysis by plasmonic structures arranged by DNA and, for example, in FRET and dye particle rulers (so-called nanometer rulers).

They are additionally used to present the super-resolution properties of microscopy for this purpose. The publication by Forthmann C. et. al., Laborpraxis, September 2011, pages 70 to 72 and Steinauer c., et al., 2009, Angew Chem Int Ed Engl 48, 8870-8873 discloses so-called nanometer rulers as structures which bear individual dyes at precisely defined intervals. These nanometer rulers described therein are used to determine experimentally the resolving power of the microscope. Relevant nanometer rulers are produced by DNA nanostructures, the DNA origami. In this regard, nanometer rulers are described which consist of simple DNA origami, usually simple rectangles. Individual dyes are arranged thereon at a predetermined interval so that the resolving power of the microscope can be thus ascertained.

For quantitative measurements in the area of fluorescence microscopy, it is of critical importance to know all the parameters of the microscope; especially for experiments which determine the absolute brightness (number of photons) of the samples labeled with labeling molecules, more particularly those where the labeling molecules are such as dyes, e.g. fluorescent dyes, it is necessary beforehand to carry out a calibration using a defined calibration sample. Said calibration sample must emit a reliable number of photons per second for a given excitation output from the light source so that it is possible to subsequently carry out a quantitative measurement of the sample to be analyzed. In the case of sequential measurements within a series of experiments, it must be ensured that the sample under study is always illuminated with the same or at least a defined excitation output. Accordingly, it is helpful to have the calibration sample at hand with every measurement. Further, it is helpful to determine the brightness density of the measuring device. That is, to avoid any impairing quenching effects of the labeling molecules, the brightness density should be known. The brightness density identifies the highest number of labeling molecules per volume possible without significant impairing quenching effects. The quenching effect is well known to the skilled person occurring in cases where the number of labeling molecules, e.g. of fluorophores, per volume is too high. The quenching effect does not allow quantitative analysis. However, the presence of a higher number of fluorophores is advantageous with respect to the brightness and the stability of the brightness. Further, larger number of labeling molecules allows to use lower excitation output.

So far, attempts have been made to determine the measurement of the excitation output by means of a light-sensitive detector. It is arranged in the beam path of the excitation light. However, the disadvantage here is that the excitation light intensity actually arriving in the sample is not measured. In some cases, such a measurement is not even possible owing to specific peculiarities of the method, for example in the case of TIRF excitation. Moreover, the light-sensitive detector measures the integral intensity, but the intensity of the excitation light is subject to great heterogeneity, which is not taken into account. Alternatively, so-called beads have been used to date. However, a disadvantage thereof is that the beads usually do not contain a defined number of dyes. Even for perfect beads, the number of dyes is determined by the Poisson distribution, i.e., a relatively broad scattering is obtained for the distribution of the number of dyes. Moreover, the dye molecules are present in the beads in an unordered manner, and so interactions between the individual dye molecules occur. The result is that, in measurements in which individual dye molecules are intended to generate a detectable difference in the measured brightness of the sample, the signal is no longer proportional to the number of dyes. The sensitivity of a microscope cannot be precisely determined owing to the relatively large signal heterogeneity. It is also no longer possible to calibrate the sensitivity to the number of detectable dyes, since not all dyes are equally bright. Similarly, it is not possible to exactly deduce an excitation output prevailing at a site. Further, it is desired to provide the labeling within low dimension, thus, allowing precise determination of small distances between each of the labelings useful e.g. in nanorulers. On the other hand, determining the optimum brightness density allows to provide small labeling with brighter and more contour sharpness.

Recently, nanostructure barcode probes have been described in WO 2012/058638 A2. However, the barcode probes described therein are not useful for calibration of measuring derives, like microscope. In particular, the barcode probes do not allow any calibration for quantitative analysis.

It is therefore an object of the present invention to provide calibration samples and arrays in order to allow appropriate setting of the relevant measuring device parameters, such as those of a microscope. Moreover, the calibration samples can be used as comparative samples containing an exactly defined number of dyes which can be used to estimate the sensitivity of the microscope. Furthermore, by means of intensity comparisons with samples or regions in samples having an unknown dye number, concentrations or even quantitative molecule numbers (in absolute dye numbers) can become determinable.

### DESCRIPTION OF THE DRAWINGS

FIG. 1a is a diagram of a rectangular DNA origami having 36 fluorophore positions;

FIG. 1b is a graphical analysis of the spatially integrated photon number based on the number of labeling molecules;

FIG. 1c is a bar graph showing a random distribution of fluorophores;

FIG. 1d is a bar graph showing the lifetime of the fluorescence in the case of the DNA origami sample;

FIG. 1e is a graph contrasting the DNA origami sample with commercially used beads;

FIG. 2a is a diagram of a rectangular DNA origami with a distance of 71 nanometers between two lines;

FIG. 2b is a graph illustrating how STED technology can resolve an interval between two lines;

FIG. 3a is a diagram of rectangles having two ATTO647N molecules at intervals of 6, 12, and 18 nm designed in DNA origami; and

FIG. 3b is a graph demonstrating it is possible to determine an interval of 5.7 nm.

### DESCRIPTION OF THE INVENTION

In a first aspect, the present invention is directed to an array for calibrating a measuring device, more particularly a microscope, using labeling molecules, having a calibration sample having a first structure based on a DNA origami and optionally at least a second structure based on a DNA origami, wherein the DNA origami are formed into a predetermined structure by means of short DNA segments and optionally said DNA origami are arranged on a support, characterized in that a predetermined number of the short DNA segments of the DNA origami has a predetermined number of a labeling molecule and the number of labeling molecules of the first structure based on a DNA origami differs from the number of labeling molecules of the optionally at least second structure based on a DNA origami.

A “structure based on a DNA origami” is understood here to mean a DNA origami formed from a scaffold DNA strand and short DNA segments which form a predetermined structure of the scaffold DNA strand. The structure based on a DNA strand can comprise further components such as dyes, plasmonic structures, biological molecules such as proteins, enzymes, nanoparticles, and small molecules such as biotin. Alternatively, the structure based on a DNA origami can also be constructed solely from short DNA segments, as recently described by Wie B., et. al., Nature, 485, 623-626, 2012.

A “first” and “at least a second” structure means here that the structures have a differing number (n) of labeling molecules, where n is the number of labeling molecules and n equals zero can be the negative control. Optionally, the structures can also be present linked to one another, for example via appropriate linkers including DNA strands.

Here, it was found that, surprisingly, the properties of the labeling molecules that are determinable on the measuring device, such as the fluorescence microscope, more particularly the fluorescence intensity of fluorophores used as labeling molecules, are directly proportional to the number of labeling molecules, more particularly the number of fluorophores, present in the DNA origami. As a result, it is possible to provide an ideal and highly stable brightness standard even for labeling molecules of high intensity. It has become apparent that, surprisingly, the fluorescence of the fluorophores is not interfered with or negatively affected by adjacent fluorophores. This means that the basic concept behind the present application is to arrange a defined number and type of labeling molecules, more particularly fluorescent dyes, on DNA origami nanostructures, so that said structures can be used as calibration samples and corresponding array for measuring-device calibration, more particularly microscope calibration. The great advantage of the DNA origami used as the basis of said calibration sample is the defined and predetermined structure, which is especially robust. As a result, it is possible to arrange a predetermined number of labeling molecules on predetermined positions. Accordingly, using suitable methods, it is then possible to determine the intensity, more particularly the number of photons, via the number of said molecules in order to thus attain calibration of the system in relation to the fluorescence intensity. As a result, it is possible to calibrate said measuring device for further quantitative measurement of fluorescence.

Using DNA origami technology, it is possible to attach a defined number of dye within a diffraction-limited point. The beads hitherto used for this purpose allow such predetermined positioning of these labeling molecules to a much more limited extent, and so the beads are not suitable for measuring-device calibration. The array according to the invention or the calibration samples according to the invention are especially suitable as standards for fluorescence microscopy. In contrast to the beads hitherto described in the prior art, the arrays and calibration samples according to the invention have a greater homogeneity. Furthermore, the lifetime of these standards compared to beads having identical labeling molecules is increased. The calibration samples or arrays according to the invention suitable as standards for measuring devices can also be used as those for other spectroscopic parameters, such as fluorescence lifetime. Through DNA origami technology, it is possible to provide both a high degree of scalability with regard to the amount of samples produced and flexibility with regard to the number and type of dyes used. The calibration samples or arrays according to the invention for measuring-device calibration are especially suitable as those for microscopy, more particularly fluorescence microscopy. With appropriate labeling molecules, these calibration samples or arrays are however also usable in other areas of measurement, for example in the area of absorption measurement or in the area of Raman spectroscopy, nanophotonics or plasmonics.

The arrays according to the invention additionally make it possible to determine the sensitivity of the measurement method.

The term “labeling molecule” is understood here to mean a component which is attached to the DNA origami and generates the signal to be measured, for example a fluorescent dye, a nanoparticle, semiconductor nanocrystal, or enzyme.

The term “short DNA segments” is understood here to mean the nucleotide molecules which are referred to as “staple strands” and which have a sequence complementary to a sequence of the scaffold DNA strand or another short DNA segment. Furthermore, said short DNA segments can be used to provide the long DNA strand with the predetermined structure. Alternatively, the short DNA segments can be those which hybridize with the DNA scaffold strand of the DNA origami in predetermined regions.

As used herein, the “short DNA segments” include embodiments wherein the labeling with the labeling molecules is with the short DNA strands hybridising and forming the scaffold DNA strand. In another embodiment, the short DNA segments include DNA strands being elongated with a DNA moiety not hybridising with the scaffold DNA strand. These elongation allow hybridisation of another oligonucleotide being labeled with the labeling molecules whereby this other oligonucleotide has a sequence substantially complementary to the elongation of the short DNA segment hybridisied to the scaffold DNA strand. That is, the term “short DNA segments” as used herein include the embodiment of two or more oligonucleotides wherein one of the oligonucleotides is a staple strand and the at least further oligonucleotide is a short DNA strand hybridising thereto and being labeled with labeling molecule(s).

The term “DNA”, as used here, is understood to mean not only strands of deoxyribonucleic acid, but also analogous structures, such as strands of ribonucleic acids, PNA, etc.

In a preferred embodiment, the labeling molecules are a fluorophore which is arranged on the DNA origami in a predetermined number. Positioning takes place using the short DNA segments. As a result, it is possible for a predetermined number n of labeling molecules to be present on a DNA origami. Here, n is preferably an integer from 0 to 600, for example 1 to 400 or up to 300, such as 1 to 200, 2 to 100, more particularly 0, 1, 2, 4, 8, 16, 32, 64 etc. or 10 and a multiple of 10. More particularly, in an embodiment of the present invention, the array contains at least one second DNA origami structure as calibration sample, which does not comprise any labeling molecules. Alternatively, an at least second DNA origami structure can be present and said at least second DNA origami has a predetermined number of labeling molecules that is different from the first DNA origami. For instance, it is preferred that this array has a DNA origami with, for example, 12, 24, 36, etc. labeling molecules to allow appropriate measuring-device calibration. Appropriate calibration is achieved here by measuring fluorescence intensity of the corresponding DNA origami with the predetermined number of labeling molecules and carrying out the calibration through appropriate analysis of the photon number across the surface or per DNA origami.

The term “calibration” is understood here to mean quantifying a measured variable on the basis of one or more reference samples or determining the properties of an apparatus, such as the sensitivity.

The array according to the invention is preferably one in which the short DNA segments in a predetermined number have a predetermined number of a labeling molecule, wherein said short DNA segments may have different labeling molecules of a predetermined number. This means that, in the case of fluorophores, said labeling molecules have different emission spectra. This allows measuring-device calibration, more particularly fluorescence microscope calibration, not only for one dye but also for dyes of different emission spectra.

The array can be one which is arranged on a support, more particularly a transparent support (such as glass). A person skilled in the art is aware of appropriately suitable methods for fixing the DNA origami on the support. Said methods involve the use of biotin/avidin systems, etc.

It is further preferred that, for example, when applying the DNA origami as calibration samples on a support, they are embedded on the support, for example in a material comprising/composed of polyvinyl alcohol and glycerol.

Alternatively, said array can also be added as internal calibration sample to a sample to be analyzed. This means that the calibration samples according to the invention and arrays according to the invention can, on the one hand, be used at the start, at the end and/or in between for calibrating the measuring device and the samples being analyzed are measured separately therefrom. Alternatively, the calibration sample or array according to the invention can be measured simultaneously with the sample to be analyzed and quantification, especially of fluorescence intensity, can thus be achieved with great accuracy.

In a further aspect, the present invention is directed to the use of an array according to the invention or a calibration sample according to the invention for measuring-device calibration in order to quantify measurement signals, more particularly the number of photons per unit time, measured using a sensor and/or for calibration of measuring device resolution.

It was found that, surprisingly, there is a direct proportional relationship between the number of fluorophores and the fluorescence intensity of the fluorophores arranged on the DNA origami. In contrast to fluorophores used in known beads, there is no interaction between the fluorophores arranged on the DNA origami at predetermined positions. Thus, there is no self-quenching of the fluorophores. Due to the absence of these effects influencing negatively the measuring signals, it is possible to obtain higher brightness densities (emitted photons per volume of labeling molecules) with the arrays and methods according to the present invention compared to calibration samples known in the art. Furthermore, the lifetime of the labeling molecules, more particularly the fluorophores, is very homogeneous and an interaction between the fluorophores and a resulting change in emitted photons are not observed. This is particularly the case when the labeling molecules, the fluorophores, on the DNA origami are spaced at an interval of at least 6 nanometers from one another. However, in another embodiment, the labeling molecules are present in high density on the DNA origami, e.g. at intervals of 6 nm or less. As a result, direct labeling molecule interactions and self-quenching are avoided and the described direct proportional relationship between the number of labeling molecules and fluorescence intensity is attained. It is possible for an array to contain at least 2 different DNA origami, such as 3, 4, 5 or more. “Different DNA origami” are understood to mean DNA origami which have a different number of labeling molecules. Owing to said different DNA origami, it is possible to achieve a corresponding calibration curve using a single array and thus allow accurate and robust quantification of fluorescence intensity. By means of the quantification, it is possible to determine with high accuracy the number of labeling molecules in a sample and thus possibly the number of labeled components, such as labeled molecules, in the sample, with spatially resolved quantification being possible in particular.

In a further aspect, the present application is directed to a method for calibrating a measuring device, comprising the steps of:
providing at least one calibration sample having a predetermined number of labeling molecules, more particularly an array according to the invention with a calibration sample;
measuring said at least one calibration sample under the given conditions, more particularly under a given excitation output, using an appropriate sensor;
calibrating the measuring device on the basis of the measurement of the at least one calibration sample under the given conditions, more particularly measurement of the emitted photons per unit time using a sensor, preferably with the aid of a processing unit.

The method according to the invention is especially suitable for calibrating microscopes, more particularly fluorescence microscopes. The measuring device is one for measuring fluorescence. Said measuring device is especially one which allows optical resolution at super-resolution, i.e., in the nanometer range.

The method according to the invention is notable for the fact that the measurement under a given excitation output from a light source measures the number of photons emitted by fluorophores as labeling molecules per time using a sensor and the measured value and a predefined standard curve is used to carry out the calibration and/or at least two measured values obtained from at least two calibration samples are used to carry out a calibration via calculation of a standard curve.

The method according to the invention is especially suitable for calibrating measuring devices, more particularly those for measuring fluorescence such as fluorescence microscopes for quantitative measurement of said fluorescence. In one embodiment, there are in this connection at least two different labeling molecules, more particularly two different fluorophores having different excitation and emission wavelengths, to which the measuring device can then be calibrated.

Owing to the presently found direct proportional relationship between the number of fluorophores of the labeling molecules present with the DNA origami structure and the fluorescence intensity of said DNA origami, it is possible to provide calibration samples as standards for quantitative determination of the number of dyes. Said standards are especially suitable for applications in the area of super-resolution microscopy, for example for STED microscopy. It was found that it was possible to resolve two intensity points lying at an interval of, for example, from 6 to 94 nm from another and to differentiate them in terms of their intensity in order to allow quantitative determination of intensity. The method according to the invention and the calibration samples according to the invention and also the array thereof on a support further allow the sensitivity of the measurement methods to be determined. This means that, by means of a simple array with DNA origami with a differing number of labeling molecules, it is possible to determine the sensitivity of the measurement method, i.e., the required number of labeling molecules per measurement point.

Lastly, a kit for calibrating a measuring device, more particularly a measuring device for measuring fluorescences, such as a fluorescence microscope, is provided. Said kit comprises an array according to the invention with calibration sample.

The array according to the invention with calibration sample can, as explained above, be provided on a support, optionally embedded in an appropriate embedding medium. Alternatively, the array with calibration sample can also be directly added to the sample to be analyzed. In this regard, in one embodiment, the labeling molecule of the calibration sample can be different from the labeling molecule of the sample to be analyzed. In another embodiment, the labeling molecules are identical.

Lastly, the present application provides a computer program with program coding means, more particularly stored on a machine-readable medium; said program is set up for carrying out the method according to the invention when the computer program is executed on a processing unit.

The invention will be illustrated in more detail using the following examples, without being restricted thereto.

### DNA Origami Structures as Fluorescence Standards

Two different DNA origami structures were used: rectangular DNA origami and a six-helix bundle. The unmodified and modified short DNA segments (staple strands) were obtained from MWG (Munich, Germany) or IBA (Göttingen, Germany) at a concentration of 100 μM and were used without further purification. The DNA origami were formed using a nmol ratio of 1:30 between viral DNA and unmodified short DNA segments and in a ratio of 1:100 between viral DNA and modified short DNA segments. To prepare the scaffold strands from viral DNA, E. coli strain K91 was infected with the corresponding M13MP18 phages and, after amplification, the phage particles were removed, purified and the single strand DNA extracted, as described in Castro, C. E., et. al., Nature Methods: 2011, (3), 221-229. The concentration was adjusted appropriately to 100 nmol. The six-helix bundles were purified by means of gel electrophoresis. The rectangular DNA origami was purified based on the publication (Rothemund, Nature (2006) 440, 7082, 297-302) after thermal annealing in a thermal cycler using Amicon centrifuge filter devices (100,000 MWCO 300×G 10 minutes).

For stabilization of the structures, for storage and for improvement of the portability of the DNA origami on the supports, a polymer was optionally used, prepared using 10 g of “Mowiol 488” (Carl Roth, Karlsruhe, Germany), 25 g of glycerol and 100 ml of 0.1 M Tris (buffered at pH 7.2). The supports used were microscope slides and cover slips: the labeling molecules used were: ATTO647N or Alexa488 fluorescent dyes. The labeling molecules were bound to the corresponding short DNA segments according to known methods.

### DNA Origami Immobilization

Various methods were used to immobilize the DNA origami. Chemical immobilization was achieved by means of BSA-biotin/BSA neutravidin surfaces, as described in Piestert, Sauer, Nano Letters, (2003) 3, 7, 979-982. Alternatively, electrostatic immobilization was achieved either by coating the surface with PLL (Biochrom, Berlin, Germany) or by addition of MgCl₂ to the solution.

### Measurement of Brightness

Brightness was measured using a confocal microscope based on an inverse microscope (IX-71, Olympus). For excitation of the dye ATTO647N (ATTO-TEC), an 80 MHz pulsed diode laser (LDH-D-C-640) with 640 nm wavelength was used which was coupled into the objective lens (UPlanSApo60XO/1.35 NA, Olympus) by means of a dichroic beam splitter (z532/633, Chroma). The emitted fluorescence was separated from the excitation light using appropriate filters (ET 700/75m, Chroma; RazorEdge LP 647, Semrock) and focused on an APD (τ-SPAD-100, Picoquant). The detected signal was further processed using a PC card (SPC-830, Becker&Hickl) and evaluated using self-written LabVIEW software (LabVIEW2009, National Instruments).

### STED Microscopy

The STED measurements were carried out using a commercial Leica TCS-STED microscope and a commercial Leica TCS-STED CW microscope. For the TCS-STED measurement, the excitation was 642 nanometers and the STED beam had a wavelength of 750 nanometers (80 megahertz repetition frequency, 100× oil objective lens with a NA of 1.4, effective pixel size 10.8 nm. For CW-STED, the values were: 492 nanometers for the excitation wavelength and 592 nanometers for the STED beam. (100× oil objective lens with a NA of 1.4, effective pixel size 10.8 nm.

### Super-Resolution Imaging in Multiple Colors

The super-resolution multicolor microscopy was carried out on an inverse Olympus IX-71 tripod with TIRF (total internal reflection) excitation. The objective lens used was a UPlanSApo 100x NA=1.4 from Olympus. For excitation, three different lasers were used: Sapphire 488 (λ=488 nm, Coherent, Dieburg, Germany), Sapphire 568 (λ=568 nm, Coherent) and ibeam smart (λ=639 nm, Toptica Photonics, Munich, Germany). The laser lines were coupled in via a triple-band beam splitter (Chroma z476-488/568/647, AHF Analysentechnik) for blue and red excitation and via a single-band beam splitter (Semrock, Laser BS z561, AHF). Depending on the excitation wavelength, the fluorescence was filtered with one of the following filters: Semrock BrightLine Exciter 531/40 (blue), Semrock BrightLine HC 609/54 (yellow), Semrock RazorEdge LP 488 RS, Semrock RazorEdge LP 647 RS (both red, all AHF Analysentechnik). The fluorescence was recorded using an EMCCD camera (Ixon DU-897, Andor Technology, Belfast, Northern Ireland) with an integration time of 8.6 ms. The effective pixel size was 100 nm. The measurements were done on a BSA-biotin-neutravidin surface and an ambient buffer consisting of 50 mM TRIS pH 8.0, 10 mM NaCl, 12.5 mM MgCl₂, 1% w/w glucose, 10% v/v enzymatic oxygen scavenging system and 140 mM 2-mercaptoethanol.

### Standards for the Ultra-High Resolution Imaging

The ultra-high resolution microscopy was carried out by stepwise photobleaching and reconstruction of the point spread functions of the respective fluorescent dyes. To this end, the red channel of the experimental assembly was used as in the section “Super-resolution imaging in multiple colors”. The integration time of the camera was in this case 50 ms. The dye used was Atto647N in 1×PBS, containing therein 12.5 mM MgCl₂, 1% w/w glucose, 10% enzymatic oxygen scavenging system, 2 mM methyl viologen and 2 mM ascorbic acid.

### Example 1

### Brightness Standards Based on DNA Origami

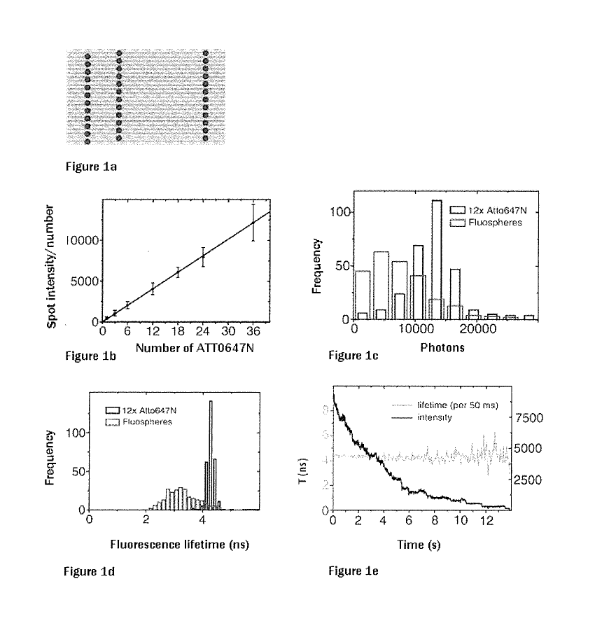

The ATTO647N-labeled short DNA segments were used in the self-assembly of the DNA origami. FIG. 1a shows a corresponding diagram of a rectangular DNA origami having 36 fluorophore positions. FIG. 1b shows the analysis of the spatially integrated photon number based on the number of labeling molecules. The linear direct dependence of the number of photons as a measure of the brightness of the number of incorporated fluorophores can be clearly seen. To this end, DNA origami having 12, 24 and 36 ATTO647N molecules were used. It is clear that there is no discernible self-quenching which leads to a reduction in the photons per spot. In contrast, experiments with commercially available beads in which the fluorophores are randomly distributed show that self-quenching occurs (FIG. 1c). Furthermore, the lifetime of the fluorescence in the case of the DNA origami sample is very homogeneous in contrast to the commercially used beads (FIGS. 1d and e).

This experiment shows that fluorophore interactions do not occur in the case of the DNA origami. In the DNA origami, the fluorophores are arranged at an interval of about 6 nanometers. In contrast, commercially available beads having a disordered fluorophore distribution exhibit interactions between the individual fluorophores, leading to a self-quenching effect.

### Example 2

### Standards for STED Microscopy

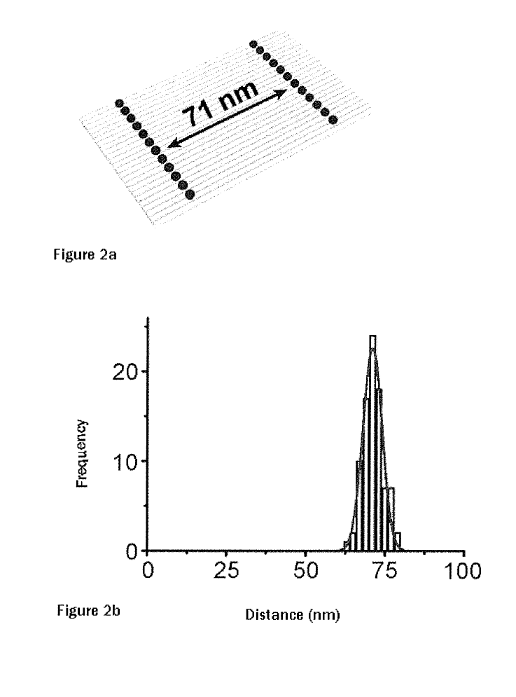

STED (stimulated emission depletion) was the first super-resolution microscope technology which breached the diffraction limit. DNA origami rulers were prepared here for both pulsed and continuous STED. To this end, corresponding rectangular origami were prepared with a distance of 71 nanometers between the two lines composed of, in each case, 12 ATTO647N molecules (see FIG. 2a). Said DNA origami were immobilized on polylysine-coated cover slips and covered with a polymer layer. Using STED technology, it was possible to resolve the interval between the two lines composed of, in each case, 12 molecules, and it was possible by means of STED microscopy to determine the distance between the two lines to 71±3 nm, as shown in FIG. 2b. Using STED with pulsed excitation, it was also possible to resolve lines at an interval of 44 nanometers. Similar results could be achieved with Alexa 488 fluorophores (data not shown).

### Example 3

### Standards for Ultra-High Resolution Imaging

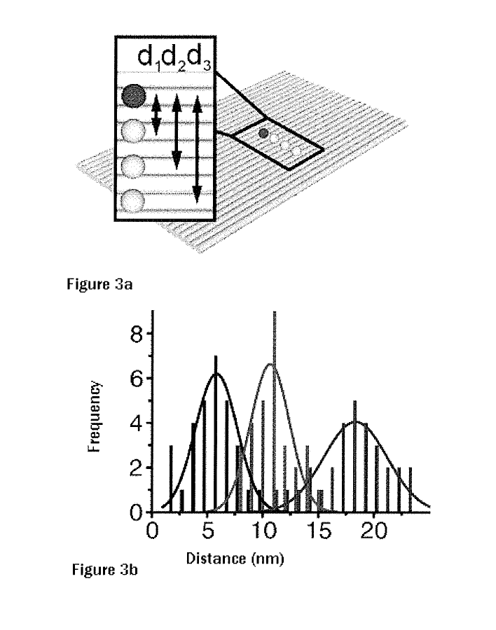

The resolution of super-resolution microscopy below the diffraction limit is normally limited by (i) photobleaching, (ii) the measured photon numbers in an “on state” and the on/off cycle or simply because of the stability of the structure. Here, rectangles having two ATTO647N molecules at intervals of 6, 12 and 18 nm were designed in DNA origami (see FIG. 3a). Said DNA origami were immobilized with 5 biotin-labeled strands. To avoid limitation by the number of photons, the fluorescence of the dyes was captured until photobleaching. Subsequently, the positions of the individual dyes were determined by subtracting the point spread function of the longer-lived dye from the point spread function before the first photobleaching step. The individual molecules were localized in reverse order of the photobleaching and the intensity distribution of the second molecule was subtracted from the first part of the transition. By way of example, it was possible to determine an interval of 5.7 nm, which agrees well with the expected interval; see FIG. 3b. The experimentally determined values across many measurements for the three intervals were d₁=5.8±2.9 nm, d₂=10.7±1.8 nm and d₃ 18.3±5.7 nm, and are thus very close to the expected values.

### Example 4

### Super-Resolution Imaging in Multiple Colors

One possibility of super-resolution imaging is the successive localization of individual, randomly blinking or photoactivatable molecules. In these experiments, the majority of the molecules is brought randomly to a nonfluorescent off state, and so the remaining molecules still in an on state can be recorded and localized. It was found that DNA origami can be used to resolve two dye molecules at an interval of −90 nm. The DNA origami were immobilized on a BSA-biotin-neutravidin surface via five biotin molecules. For the dyes Alexa488 and Alexa 568, reduction-induced radical blinking was used. For Alexa647, thiol-induced blinking was used.

### Example 5

### Stability of the Standards

To improve the stability and the storability of the standards according to the invention, they were coated with a layer of polyvinyl alcohol and glycerol. It was found that these samples show no substantial loss in imaging quality even after storage for up to 12 months at −20° C. For some standards, addition of 1% β-mercaptoethanol may be advantageous.

1. An array for calibrating a measuring device using labeling molecules, the array having a calibration sample having a first structure based on a DNA origami and optionally at least a second structure based on a DNA origami, wherein the DNA origami are formed into a predetermined structure by means of short DNA segments and optionally said DNA origami are arranged on a support, characterized in that a predetermined number of the short DNA segments of the DNA origami has a predetermined number of a labeling molecule.

2. The array according to claim 1 for calibrating a microscope.

3. The array according to claim 1, characterized in that the labeling molecule is a fluorophore.

4. The array according to claim 1, characterized in that there is a second DNA origami structure as calibration sample, which does not comprise any labeling molecules, and/or that there are at least two different structures based on DNA origami and said at least two DNA origami have a predetermined, differing number of labeling molecules.

5. The array according to claim 1, wherein the short DNA segments in a predetermined number have a predetermined number of a labeling molecule, characterized in that the short DNA segments have different labeling molecules in a predetermined number.

6. The array according to claim 1, characterized in that the support is a transparent material, more particularly a glass.

7. The array according to claim 1, characterized in that the DNA origami are embedded on the support.

8. The array according to claim 7 wherein the DNA origami is embedded in a material containing or composed of polyvinyl alcohol.

9. The array according to claim 1, characterized in that it is added as internal calibration sample to a sample to be analyzed.

10. The array according to claim 1 wherein the labeling molecules are arranged with high density on the structure, preferably wherein the distance between each of the labeling molecules is 6 nm or below.

11. The array according to claim 10 for determining the optimum brightness density of the measuring device.

12. Use of an array according to claim 1 for calibration of quantification of the measurement signals, more particularly the number of photons per unit time, measured using a sensor and/or for calibration of measuring device resolution.

13. A method for calibrating a measuring device, comprising the steps of:
providing at least one calibration sample having a predetermined number of labeling molecules, more particularly an array with a calibration sample according to claim 1;
measuring said at least one calibration sample under given conditions, more particularly under a given excitation output, using an appropriate sensor;
calibrating the measuring device on the basis of the measurement of the at least one calibration sample under given conditions, more particularly measurement of the emitted photons per unit time using a sensor, preferably with the aid of a processing unit.

14. The method according to claim 13, wherein the measuring device is a device for measuring fluorescence.

15. The method according to claim 14 wherein the measuring device is a fluorescence microscope.

16. The method according to claim 13, characterized in that the measurement under a given excitation output from a light source measures the number of photons emitted by fluorophores as labeling molecules per time using a sensor and a.) the measured value and a predefined standard curve are used to carry out the calibration and/or b.) at least two measured values obtained from at least two calibration samples are used to carry out a calibration via calculation of a standard curve.

17. The method according to claim 13 for measuring-device calibration for quantitative fluorescence measurement.

18. The method according to claim 13, wherein at least two different labeling molecules, more particularly two different fluorophores having different excitation and emission wavelengths, are calibrated.

19. The method according to claim 13 for determining the brightness density of the measuring device.

20. A kit for calibrating a measuring device, more particularly a measuring device for measuring fluorescences, such as a fluorescence microscope, comprising an array according to claim 1.

21. A computer program with program coding means, more particularly stored on a machine-readable medium, set up for carrying out the method according to claim 13 when the computer program is executed on a processing unit.
